(19) United States
(12) Patent Application Publication
(10) Pub. No.: US 2003/0109219 A1
(43) Pub. Date: Jun. 12, 2003

(54) System and method for real-time simultaneous recording on playback over communication network

(76) Inventor: Zak Amselem, Geule taiman (IL)

Correspondence Address: KATTEN MUCHIN ZAVIS ROSENMAN, 575 MADISON AVENUE, NEW YORK, NY, 10022-2585, US

(21) Appl. No.: 10/013,149

(22) Filed: Dec. 10, 2001

(51) Int. Cl. H04H 7/00

(52) U.S. Cl. 455/3.06; 455/3.01

(57) ABSTRACT

A system and method enabling simultaneous recording of voice data coming through an input channel along with broadcasting pre-made voice data sample through an output channel, said system comprising at least one recording device, one playback device, and a serial time division multiplex (TDM) bus, wherein the transmitting channel of the recording device is connected to the receiving channel of the playback device, and the transmitting channel of the playback device is connected to the receiving channel of the recording device.

According to a preferred embodiment of the present invention, the system provides the user with a real time karaoke service. A user of the system is able to select a song, record his own singing while listening to said song, and send the said song to predefined recipients.

### BACKGROUND OF THE INVENTION

The invention relates to a method of recording data in real time simultaneously with playback over a communication network. More specifically, a method and system enabling real-time karaoke.

For purposes of this disclosure, by the term “communication network” is meant at least two wire-line or wireless devices connected through cellular, wires, cables, or other means for communication. A wireless device can mean a mobile phone, a portable computer, a personal digital assistant, or any other similar-type device capable of receiving, transmitting, and/or manipulating data.

Sing-along (karaoke) systems and concepts have been widely implicated in many different ways. For example, U.S. Pat. No. 6,062,868 discloses a sing-along (karaoke) system said to be more cost-effective then similar-type systems. U.S. Pat. No. 6,083,009 presents a karaoke service method and system enabling downloading of karaoke data to a portable karaoke device, such as a mobile telephone.

The present invention uses an Interactive Voice Response system (hereinafter: “IVR system”), to automatically answer an incoming call and to communicate with the user. IVR systems have been commonly used to provide voice prompts that supply information to a user, request data from the user, and present the user with a plurality of selectable options. It is known to employ automated systems that provide voice messages to a user over a telephone line and processes the user's tone type telephone key presses as input. The messages can be tape recorded human voice messages or machine generated speech. The user can access the system by dialing a specific telephone number. The system automatically answers the telephone call and begins interacting with the user.

IVR systems have been used for various implications. For example, U.S. Pat. No. 5,179,585 discloses an integrated voice messaging/voice response system. Through one telephone call, a user can be transferred among various application modules (i.e. services) through the use of an interactive voice response module that offers a menu of available modules (a “compound session”). The system may require entry of an account number, a customer number or a password before access to the application modules is allowed. U.S. Pat. No. 5,193,110 discloses an integrated services platform for telephone communications. A user is able to access an information service via a voice menu. A master control unit automatically connects the user to a selected APU (application processing unit) and the APU then the user with the requested information. Voice menus allow the caller to request several different types of services during a single call.

IVR systems have also been used to enable a cellular network user to send a song to another specific cellular network user, as well as recording and attaching, before or after selecting a specific song, a personal greeting, which will be sent along with the song to the recipient.

Known IVR systems are capable of performing one operation on each single time, either recording or transmitting, of digital date. Most of the common IVR systems automatically answer a call and interact with the user. The system plays a pre-recorded message to the user, and then, usually, requests him to press a key or record a message. Afterwards, the system switches to a mode of receiving data, until the user indicates in a certain way that he has finished providing input (by pressing a certain key, by waiting a previously programmed period of time, or by any other similar-type way). More advanced IVR systems enable the user to interrupt the system in the process of playing the pre-recorded message, by pressing a certain key or by beginning to talk. The IVR system identifies the interruption, pauses playing the pre-recorded message, and replies according to the user request.

However, no known wire-less communication system, enabling simultaneous recording of voice data coming through an input channel along with broadcasting a pre-recorded data voice sample through an output channel, currently exists. prime object of the present invention is to enable real-time karaoke based on a communication network, by enabling such simultaneous recording & transmitting,

### SUMMARY OF THE INVENTION

The present invention consists of an IVR system enabling simultaneous recording of voice data coming through an input channel along with broadcasting a prerecorded data voice sample through an output channel The system, as it is visually disclosed on FIG. 1, consists of at least one recording device, one playback device, and a serial time division multiplex (TDM) bus, wherein the transmitting channel of the recording device is connected to the receiving channel of the playback device, and the transmitting channel of the playback device is connected to the receive channel of the recording device.

### BRIEF DESCRIPTION OF THE DRAWINGS

These and further features and advantages of the invention will become more clearly understood in the light of the ensuing description of a preferred embodiment thereof, given by way of example only, with reference to the accompanying drawings, wherein—

FIG. 1 is a general diagrammatic representation of the environment in which the present invention is practiced;

FIG. 2 diagram block illustrates the structure of the karaoke system service according to the present invention.

FIG. 3 is a visual representation of the karaoke unit.

FIG. 4 is a flow-chart illustrating a preferred embodiment of the karaoke service procedure

FIG. 5 is a flow-chart describing the karaoke unit's operation.

### DETAILED DESCRIPTION OF THE PREFERRED EMBODIMENTS

Let us assume that a user desires to enjoy karaoke service and share the recording results with friends located at different physical locations. According to prior art technologies, the user must be provided with personal karaoke device or attend at public karaoke services. The user could share the karaoke results only with audience present at the same time. Alternatively the user can record the karaoke singing and distribute the recording to his friends by any conventional communication services. However this process is tiresome and not practical.

Recently cellular users are provided with greeting services enabling to send pre-recorded songs enclosed with a personal greeting. Such service lacks the experience of the real karaoke, not enabling the sender to sing along with the recorded songs.

The present invention provides the user with a new greeting service enabling the users to create real-time karaoke recordings, using conventional cellular device and distributing the recording results to their friends through the same cellular communication service. most telephony and cellular automatic services are implemented by using IVR technologies. Prior art IVR systems, as described in the background, don't enable to receive the user transmission and broadcast system playback on the same channel simultaneously. Thus, the new karaoke service as suggested by the present invention is not possible,

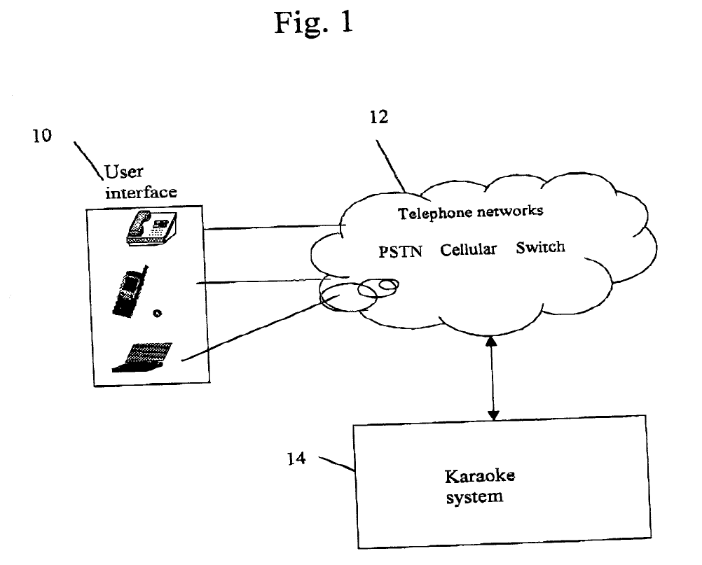

FIG. 1 illustrates the environment in which the present invention is practiced. The user is provided with conventional communication device 10 such as cellular phone or computer terminal which is connected through communication network (e.g. cellular network to the karaoke system 14 as suggested by the present invention.

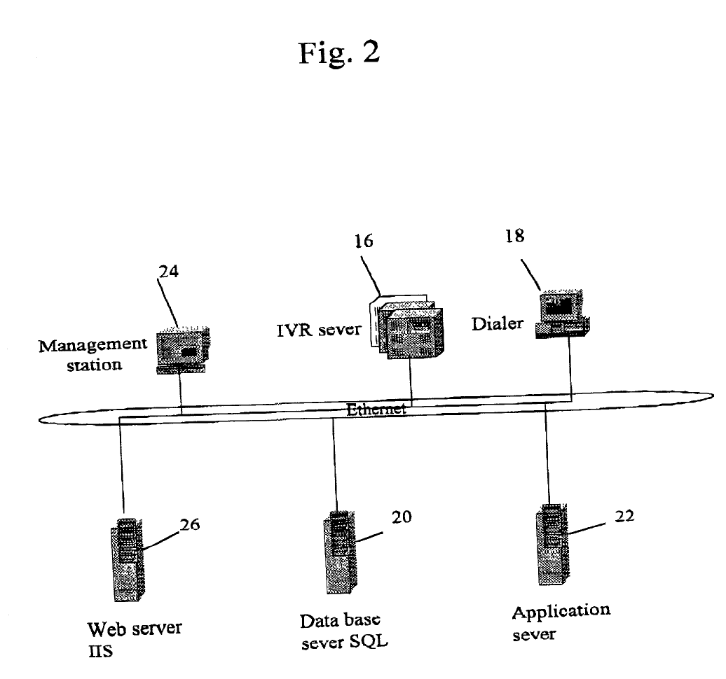

FIG. 2 diagram block illustrates the structure of the karaoke system service according to the present invention. The karaoke systems is implemented in an Ethernet environment including (VR server 16 interlaced With dialer application 18, database server 20 for storing pre-recording of songs and user karaoke service, application server 22 for managing the karaoke service, management station 24 for supervising the karaoke server and web-server 26 managing a web-site supporting the karaoke service.

The user establishes communication with the karaoke system dialer 18 by a call initiated using any known wire-line or wireless communication device 10, such as, but not limited to a telephone, a mobile phone, a personal computer, a personal digital assistant, etc, as illustrated in FIG. 1. For example, the user might access the system by calling a specific telephone or a short programmed number (ex. *69) from a cellular phone or a telephone, or a personal digital assistant.

The call is automatically diverted by the user service provider to a network of IVR servers, designed for supporting the expected number of callers. An IVR system (as described in the background) is a computerized system set to automatically prompt the caller for keypad (or spoken) input and use that input to perform actions on the recording database 20. The IVR system is supported by the application sever for managing and retrieving particular records and reading and/or rewriting them in the course of providing the karaoke service, (and/or proceeding down particular prerecorded paths in a scripted and automated telephone “conversation”). An IVR system is operated by an IVR server. Each individual IVR server is capable of handling about 60-120 callers. Therefore, to handle a large number of calls, the disclosed system employs a network of IVR servers.

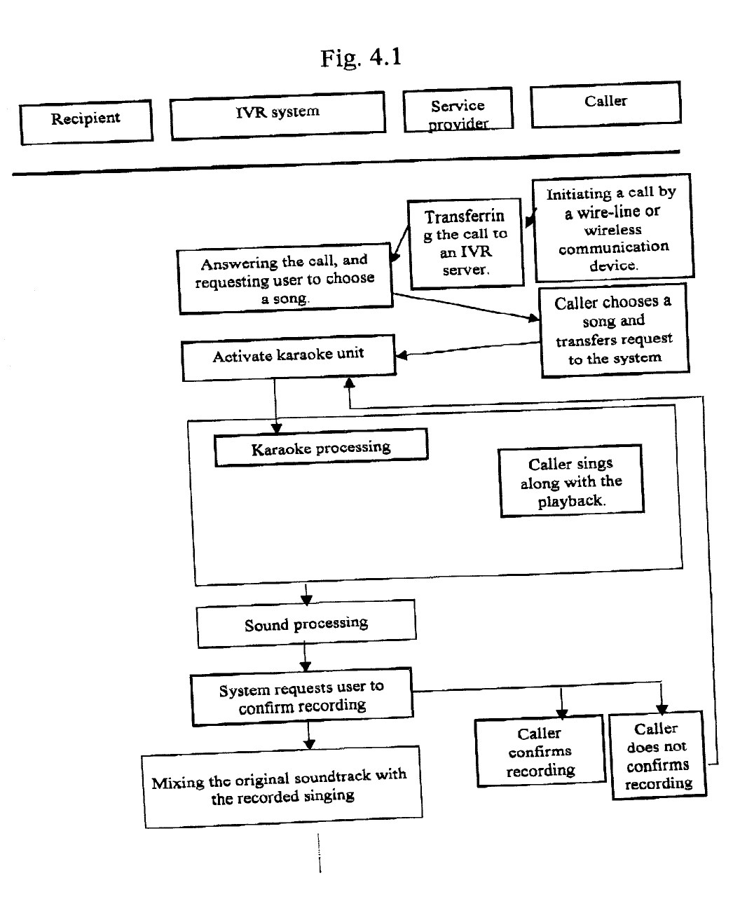

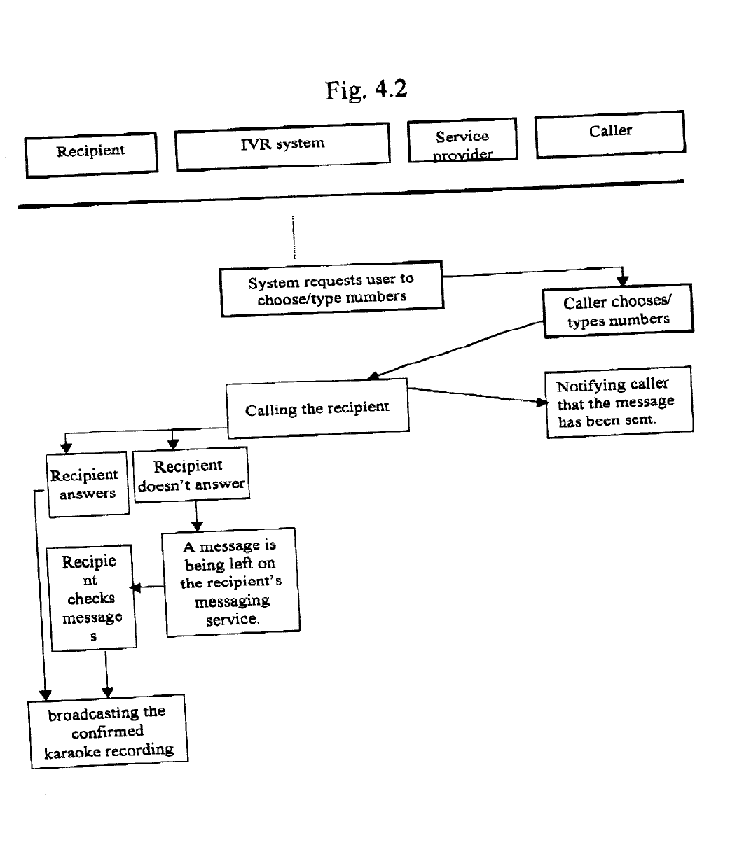

Once the connection is established, the IVR system activates the karaoke service procedure as illustrated in FIG. 4: first, the user is introduced with karaoke service, optionally help instruction is provided. Then, a menu selection program is operated enabling the user to select a song out of the available collection in the database 20. Optionally, the user may be given the option to add a video clip to the song, which will be shown by a display unit (for example: a personal computer).

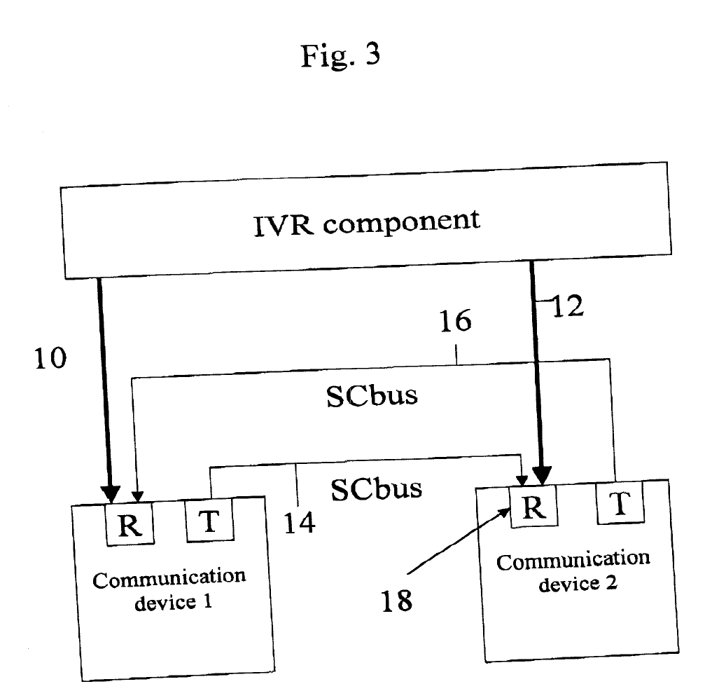

After selecting a song, and confirming the selection, the IVR operates the karaoke unit, visually presented in FIG. 3. The karaoke unit comprises at least two communication devices, and TDM SCbus. The first communication device is used for playback The second communication devise is used for recording the user singing. The SCbus is a serial time division multiplexed bus for carrying information between hardware devices in a signal processing node. The SCbus cable is used for connecting between the two communication devices, thus creating an integrated sub-system which enables recording of input data in real time, simultaneously with broadcasting pro-recorded playback.

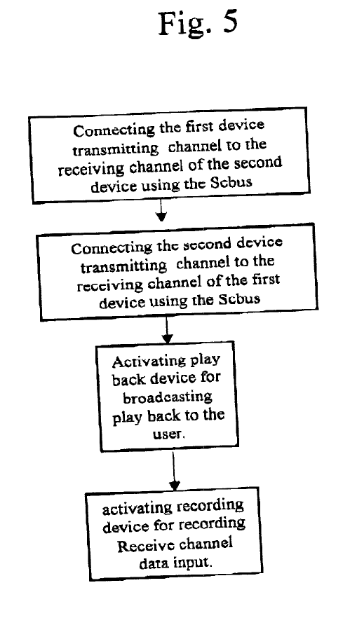

FIG. 5 describes the process of the karaoke unit's operation: First, the IVR component establishes connection between the first and second communication devices as follows (see diagram block Illustration in FIG. 3) the transmit channel of the first device is connected (by bus 14) to the receive channel of the second device and the transmit channel of the second device is connected (by buss 16) to the receive channel of the first device, once this operation is completed, the IVR component sends a signal for activating both devices, opening the device channels for transmitting and receiving voice data.

Once the karaoke connections are established, the first device starts to broadcast the chosen song playback, and the second device simultaneously records the voice data input coming through its receive channel.

After the voice data recording is finished, the system performs conventional sound processing for improving the recording's quality (for example: echo canceling), the improved recording is mixed with the prerecorded playback (hereinafter: “the karaoke recording”). Once the voice data recording is completed, the system requests the user to confirm the recording. If the user does not confirm the recording, the karaoke unit is reactivated and the user tries to record the song again. So on and so forth, until the user is pleased and confirms the recording. Further on, the system requests the user to choose or type one or more phone numbers of recipients (for example: friends, colleges, etc.) to whom he desires to send the karaoke recordings. Then, the karaoke recording is transmitted to the chosen recipients. In case this transmission is completed successfully, the system notifies the user by SMS, by WAP, or by any other similar-type communication way, that the message has been sent successfully. The recipient's wire-line or wire-less device calls or notifies the recipient, that he has received a karaoke message. In case the recipient decides to hear karaoke recording the karaoke system broadcasts the final karaoke song recording. If not, it is being recorded as message on his messaging service, and the song is broadcasted to him once he pulls out this message.

While the above description contains many specifities, these should not be construed as limitations on the scope of the invention, but rather as exemplifications of the preferred embodiments. Those skilled in the art will envision other possible variations that are within its scope. Accordingly, the scope of the invention should be determined not by the embodiment illustrated, but by the appended claims and their legal equivalents.

What is claimed is:

1. An IVR system enabling simultaneous recording of voice data coming through an input channel along with broadcasting pre-made voice data sample through an output channel, said system comprising at least one recording device, one playback device, and a serial time division multiplex (TDM) bus, wherein the transmitting channel of the recording device is connected to the receiving channel of the playback device, and the transmitting channel of the playback device is connected to the receiving channel of the recording device.

2. The system in claim 1, further comprising a receiving/transmitting device, associated with the IVR system for receiving voice data and tone-type key presses from the user, and transmitting voice data to the user.

3. The system in claim 1, further comprising sound processing tools, used to improve the recording's quality.

4. The system in claim 1, further comprising tools for mixing the output of the recording device, along with the prerecorded playback, to create a mixed karaoke voice data sample;

5. The system in claim 4, further comprising means for transmitting the mixed voice data to one or more recipients through a communication network, wherein said recipients can be provided as input by the user, or predefined by the system.

6. The system in claim 5, wherein the communication network is a cellular network, satellite network, cable network, or Internet.

7. The system in claim 5, further comprising means for playing the mixed voice data to said recipients, or recording a message on their messaging service.

8. The system in claim 1, further comprising a display unit, used by the recipient, and means for storing video data for each song, and broadcasting it to said display unit.

9. A method enabling simultaneous recording of voice data coming through an input channel along with broadcasting pro-made data voice sample through an output channel, using an IVR system, comprising at least one recording device, one playback devise and TDM bus, said method comprising the steps of:
I. Opening playback device for receiving/transmitting data communication;
II. Opening record device for receiving/transmitting data communication;
III. Connecting transmit channel of playback device to receive channel of recording device using TDM bus;
IV. Connecting receive channel of recording device to transmit channel of playback device using TDM bus;
V. Transmitting a pre-made voice data sample from playback device transmitting channel to user terminal;
VI. Recording incoming voice data from receive channel of recording device;

10. The method in claim 9, wherein the voice data is being transmitted to one or more recipient through a communication network, using a receiving/transmitting device.

11. The method in claim 9, wherein a predefined voice data sample is selected by the user, according to the following steps of:
Receiving a call by the IVR system.
Requesting the user to choose a predefined voice data sample.
Receiving user's choice and proceeding to the following steps.

12. The method in claim 9, further comprising the step of:
Performing sound processing operations on the voice data recorded in step VI, in order to improve the recording's quality.

13. The method in claim 9, further comprising the stop of:
Mixing the recording in stop VI, with the prerecorded playback, to create a mixed voice data sample.

14. The method in claim 12, further comprising the steps of:
Requesting the user to confirm the mixed voice data sample,
If the user does not confirm the mixed voice data same, repeating steps I-VI.

15. The method in claim 9, further comprising the steps of:
Requesting the user to confirm the recording,
If the user does not confirm the recording, repeating steps I-VI.

16. The method in claim 14, wherein prior to requesting the user to confirm the mixed voice data sample, it is being played to the user.

17. The method in claim 15, wherein prior to requesting the user to confirm the recording, it is being played to the user.

18. The method in claim 9, further comprising the step of:
Requesting the user to provide identifications for one or more recipients, whereas such identifications can be numbers, addresses, domain names, IP addresses, or any other identification method,

19. The method in claim 9, further comprising the step of:
Playing the recording to the recipient or recording it as a message on his messaging service.

20. The method in claim 13, further comprising the stop of:
Playing the mixed voice data sample to the recipient, or recording it as a message on his messaging service.

21. The method in claim 9, wherein the recipient is using a display unit, further comprising the step:
Broadcasting prerecorded video data to the recipient, wherein said video data is stored for each song.
